(19) United States
(12) Patent Application Publication
(10) Pub. No.: US 2012/0269207 A1
(43) Pub. Date: Oct. 25, 2012

(54) RECEIVER FOR RECEIVING AND DISPLAYING A PLURALITY OF STREAMS THROUGH SEPARATE ROUTES, METHOD FOR PROCESSING THE PLURALITY OF STREAMS AND TRANSMITTING METHOD THEREOF

(75) Inventors: Yong-seok JANG, Hwaseong-si (KR); Hong-seok PARK, Anyang-si (KR); Jae-jun LEE, Suwon-si (KR); Hee-jean KIM, Yongin-si (KR); Dae-jong LEE, Hwaseong-si (KR); Yu-sung JOO, Yongin-si (KR)

(73) Assignee: SAMSUNG ELECTRONICS CO., LTD., Suwon-si (KR)

(21) Appl. No.: 13/452,150

(22) Filed: Apr. 20, 2012

Related U.S. Application Data
(60) Provisional application No. 61/478,151, filed on Apr. 22, 2011.

(30) Foreign Application Priority Data
Mar. 29, 2012 (KR) 10-2012-0032604

(51) Int. Cl. H04J 3/02; H04J 3/04

(52) U.S. Cl. 370/535; 370/537

(57) ABSTRACT

A receiver is provided. The receiver includes a first receiving unit which receives a first stream over a broadcasting network; a second receiving unit which receives a second stream over a communication network; a data processing unit which detects aggregation information from at least one of the first and second streams, and which assembles and processes data of the first stream and data of the second stream according to the aggregation information; and an output unit which outputs the data processed by the data processing unit. Thus, relevant data can be assembled and processed easily.

### CROSS-REFERENCE TO RELATED APPLICATIONS

This application claims benefit under 35 U.S.C. §119 (e) of U.S. Provisional Application No. 61/478,151 filed on Apr. 22, 2011 in the United States Patent and Trademark Office, and Korean Patent Application No. 10-2012-0032604 filed on Mar. 29, 2012 in the Korean Intellectual Property Office, the disclosure of which is incorporated herein by reference.

### BACKGROUND OF THE INVENTION

1. Field of the Invention

The present general inventive concept relates generally to a receiver for receiving and processing a plurality of streams, a stream processing method, and a stream transmitting method. More particularly, the present general inventive concept relates to a receiver for receiving a plurality of streams being transmitted through separate routes, and combining and processing the streams according to aggregation information, a streaming processing method, and a stream transmitting method.

2. Description of the Related Art

Owing to advances in electronics and communication technologies, various electronic devices are developed and supplied. A representative example of the electronic devices is a receiver such as TV.

Recently, as the performance of the TV has enhanced, multimedia contents such as 3D contents or full HD contents are transmitted and televised. However, the volume of such contents is significantly greater than the existing contents.

However, a transmission bandwidth provided by a broadcasting network is limited. Accordingly, the size of the transmittable contents is restricted. Under this limitation, resolution reduction is inevitable. As a result, image quality is deteriorated.

To address this problem, there was an attempt to transmit various media data in various transmission environments. However, since the data are transmitted through different routes, the receiver cannot determine whether the data are relevant to each other.

For example, when a left-eye image and a right-eye image of 3D contents are transmitted in separate routes, the two images should be combined for the playback. However, it is difficult to determine whether the two images are interrelated.

### SUMMARY OF THE INVENTION

An aspect of the present general inventive concept has been provided to solve the above-mentioned and/or other problems and disadvantages and an aspect of the present general inventive concept provides a receiver for receiving, combining, and processing a plurality of streams through separate routes, a stream processing method, and a stream transmitting method.

According to an aspect of the present general inventive concept, a receiver includes a first receiving unit which receives a first stream over a broadcasting network; a second receiving unit which receives a second stream over a communication network; a data processing unit which detects aggregation information from at least one of the first and second streams, and which assembles and processes data from the first stream and data from the second stream according to the aggregation information; and an output unit which outputs the data processed by the data processing unit.

The aggregation information may be included in an elementary stream loop of a program map table of at least one of the first stream and the second stream.

The aggregation information may be recorded in a Multimedia Association Table (MAT) disposed above a Program Association Table (PAT) of at least one of the first stream and the second stream.

The data processing unit may include a first demuliplexer which detects data and the aggregation information by demultiplexing the first stream; an association controller which controls the second receiving unit to receive the second stream according to the aggregation information; a second demuliplexer which detects data from the second stream received by the second receiving unit; a first decoder which decodes the data detected by the first demuliplexer; a second decoder which decodes the data detected by the second demuliplexer; and a renderer which assembles and renders data designated by the aggregation information.

The data processing unit may include a storage unit which stores the first stream and the second stream; a first demultiplexer which detects data and first aggregation information by demultiplexing the first stream; a second demultiplexer which detects data and second aggregation information by demultiplexing the second stream; an association controller which determines data to assemble in the first stream and the second stream using the first aggregation information and the second aggregation information, and which assembles the determined data; a decoder for decoding the data assembled by the association controller; and a renderer which renders the decoded data.

The aggregation information may include at least one of a data type provided in other stream, a data transport type, a data separator, a PID, a URL, and manifest information.

A stream processing method includes receiving a first stream over a broadcasting network; detecting data and aggregation information in the first stream; receiving a second stream relative to the first stream over a communication network according to the aggregation information; decoding the data of the first stream and the second stream; assembling the decoded data according to the aggregation information; and processing and outputting the assemble data.

The aggregation information may be recorded in an elementary stream loop of a program map table of the first stream.

A stream processing method includes receiving a first stream over a broadcasting network; receiving a second stream over a communication network; detecting aggregation information from at least one of the first and second streams, and assembling and processing data of the first stream and data of the second stream according to the detected aggregation information; and outputting the processed data.

The aggregation information may be recorded in an elementary stream loop of a program map table of at least one of the first stream and the second stream.

The aggregation information may be recorded in an MAT disposed above a PAT of at least one of the first stream and the second stream.

The processing operation may include storing the first stream and the second stream; detecting data and first aggregation information by demultiplexing the first stream; detecting data and second aggregation information by demultiplexing the second stream; determining data to assemble in the first stream and the second stream using the first aggregation information and the second aggregation information, and assembling the determined data; decoding the assembled data; and rendering the decoded data.

The aggregation information may include at least one of a data type provided in other stream, a data transport type, a data separator, a PID, a URL, and manifest information.

A stream transmitting method includes generating an elementary stream comprising data; generating a program map table for the elementary stream; generating aggregation information relating to other data to be assembled with the data and recording the generated aggregation information in an elementary stream loop of the program map table; and generating and transmitting a transport stream comprising the elementary stream and the program map table. The aggregation information may include at least one of a type, a transport type, a data separator, a PID, a URL, and manifest information of the other data.

A stream transmitting method includes generating an elementary stream comprising data; generating program map table information and program association table information for the elementary stream; generating an MAT comprising aggregation information relative to other data relating to the data; and generating and transmitting a transport stream comprising the elementary stream, the MAT, the program association table, and the program map table. The aggregation information may include at least one of a type, a transport type, a data separator, a PID, a URL, and manifest information of the other data.

Hence, the plurality of the streams can be assembled and output using the aggregation information.

### BRIEF DESCRIPTION OF THE DRAWING FIGURES

These and/or other aspects and advantages of the present general inventive concept will become apparent and more readily appreciated from the following description of the embodiments, taken in conjunction with the accompanying drawings of which:

FIG. 1 is a diagram showing a media transmission and reception system according to an embodiment of the present general inventive concept;

FIG. 2 is a diagram showing a first stream transmitted over a broadcasting network and a second stream transmitted over a communication network;

FIG. 3 is a diagram showing operations of the media transmission and reception system according to an embodiment of the present general inventive concept;

FIG. 4 is a block diagram showing a receiver according to an embodiment of the present general inventive concept;

FIG. 5 is a diagram showing the placement of aggregation information in a program map table;

FIG. 6 is a diagram showing the aggregation information of FIG. 5;

FIG. 7 is a diagram showing an elementary stream loop including the aggregation information;

FIG. 8 is a diagram showing the stream transmitted via the communication network using TS over IP;

FIG. 9 is a diagram showing the stream transmitted over the communication network using IP;

FIG. 10 is a block diagram showing a data processing unit of the receiver of FIG. 4;

FIG. 11 is a diagram showing aggregation information transmission using a multimedia association table;

FIG. 12 is a diagram showing the multimedia association table of FIG. 11;

FIG. 13 is a diagram showing the stream including the aggregation information of FIG. 11 and the stream provided in TS over IP format;

FIG. 14 is a diagram showing a method for assembling data using the multimedia association table of FIG. 13;

FIG. 15 is a diagram showing the stream including the aggregation information of FIG. 11 and the stream provided in IP format;

FIG. 16 is a diagram showing a method for assembling data using the multimedia association table of FIG. 15;

FIG. 17 is an another block diagram showing the data processing unit of the receiver of FIG. 4;

FIG. 18 is a flowchart showing a stream processing method according to an embodiment of the present general inventive concept;

FIG. 19 is a flowchart showing a stream processing method according to another embodiment of the present general inventive concept;

FIG. 20 is a detailed flowchart showing the data processing step in the stream processing method of FIG. 19;

FIG. 21 is a block diagram showing a transmitter according to an embodiment of the present general inventive concept;

FIG. 22 is a flowchart showing a stream transmitting method according to an embodiment of the present general inventive concept; and

FIG. 23 is a flowchart showing a stream transmitting method according to another embodiment of the present general inventive concept.

### DETAILED DESCRIPTION OF THE EXEMPLARY EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

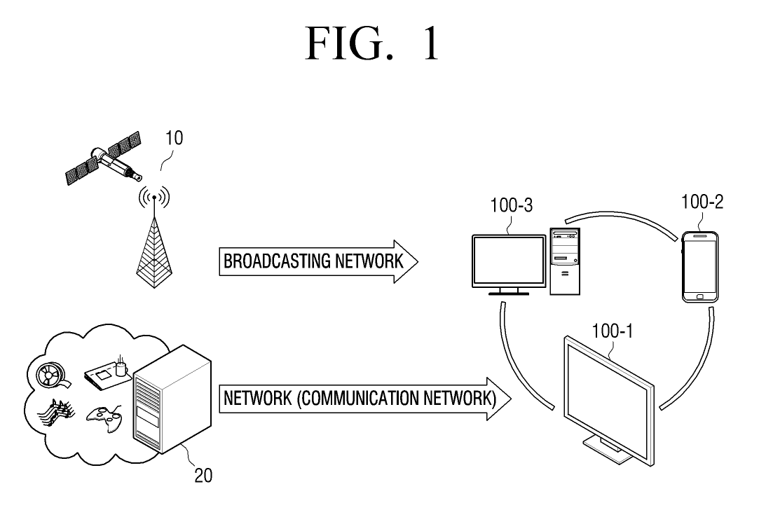

FIG. 1 is a diagram of a media transmission and reception system according to an embodiment of the present general inventive concept. Referring to FIG. 1, various sources 10 and 20 transmit media data through various transmission routes. The transmission routes include, but are not limited to, a broadcasting network and a communication network. The communication network includes, but is not limited to, various networks such as Internet, cloud network, local network, and intranet.

Receivers 100-1, 100-2, and 100-3 receive and process the media data from the connected sources, namely the broadcast source 10 and the communication network source 20. The media data can include various data such as video data, audio data, image data, and text data. While a TV 100-1, a mobile phone 100-2, and a PC 100-3 are depicted in FIG. 1, other various receivers such as set-top box, notebook PC, PDA, digital frame, e-book, and MP3 player, and the like, can be employed. While three receivers 100-1, 100-2, and 100-3 are depicted in FIG. 1, the number of the receivers is not limited and can be one or more.

The TV 100-1, which is one of the receivers, receives a stream from the broadcasting source 10 of the corresponding area via an antenna or a satellite. The TV 100-1 can receive a stream by accessing the communication network source 20 connected over the network. In this case, at least one of the two streams received from 10 or 20 includes aggregation information. The TV 100-1 combines relevant data of the two streams using the aggregation information, and plays and outputs the combined data on a screen. Besides the TV 100-1, the other receivers 100-2 and 100-3 can combine and process data in the same manner.

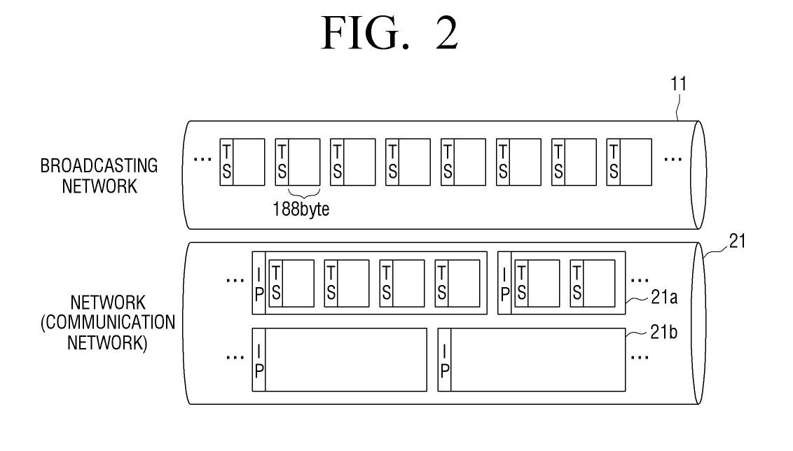

FIG. 2 depicts a stream transmitted over the broadcasting network (hereafter, referred to as a first stream) and a stream transmitted over the communication network (hereafter, referred to as a second stream). Referring to FIG. 2, the first stream 11 transmitted over the broadcasting network includes video data, audio data, and additional data, and the data is packetized and transmitted as Transport Stream (TS) packets each including a TS header and payload. While one packet includes 188 bytes in FIG. 2, the packet size can differ according to a broadcasting communication standard that is being followed in the communication.

In FIG. 2, the second stream 21 can packetize video data, audio data, and additional data to the TSs and carry them in the TS over IP format 21a, the TSs being IP-packetized or in the IP packet format 21b generated by packetizing the base data itself, namely the video data, the audio data, and the additional data.

While only the first and second streams 11 and 21 are depicted in FIG. 2, the number of the streams can exceed two.

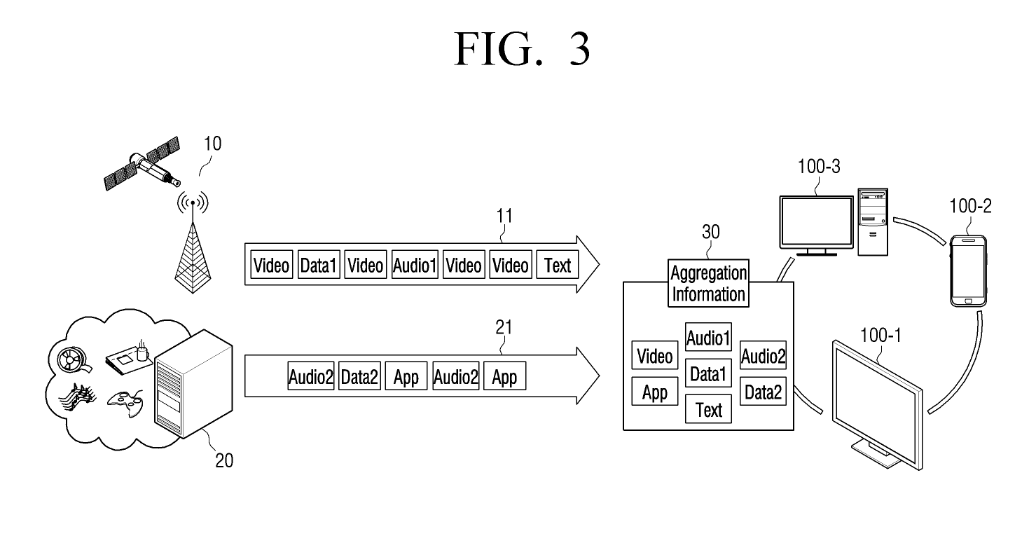

FIG. 3 depicts data assembly using the aggregation information in the media transmission and reception system of FIG. 1. Referring to FIG. 3, the first stream 11 includes video, audio1, data1, and text, and the second stream 21 includes audio2, data2, and application (app).

The aggregation information 30 includes information for designating the data in the first and second streams 11 and 21. The receivers 100-1, 100-2, and 100-2 receiving the first and second streams 11 and 21 assemble and process the video, the audio1, the audio2, the data1, the data2, the app, and the text designated by the aggregation information 30.

While the video, the audio, the data, the application, and the text are depicted in FIG. 3, image vector graphic, timed text, speech, scene descriptor, web content, and metadata can be contained in the stream and assembled according to the aggregation information.

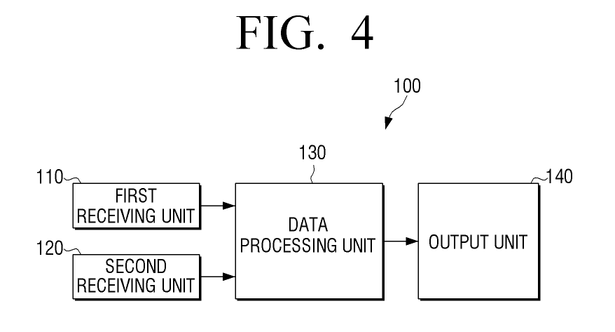

FIG. 4 is a block diagram showing essential components of the receiver according to an embodiment of the present general inventive concept. The structure of the receiver 100 of FIG. 4 can correspond to not only the receivers 100-1, 100-2 and 100-3 of the system of FIGS. 1 and 3 but also other receivers.

Referring to FIG. 4, the receiver 100 includes a first receiving unit 110, a second receiving unit 120, a data processing unit 130, and an output unit 140.

The first receiving unit 110 receives the first stream over the broadcasting network. The first receiving unit 110 can include an antenna, a tuner, a demodulator, an equalizer, and so on. Structures and operations of the antenna, the tuner, the demodulator, and the equalizer are known in the related art at least as part of broadcasting standards and are not discussed in detail herein.

The second receiving unit 120 receives the second stream by accessing the external source over the communication network. The second receiving unit 120 can include a network interface card.

The data processing unit 130 receives and detects the aggregation information in at least one of the first and second streams, and assembles and processes the data in the first stream and the data in the second stream according to the aggregation information. The data processing unit 130 can perform operations such as decoding, scaling, and rendering as part of the processing. Such operations are well-known in related art and their detailed explanations is not included herein.

The output unit 140 outputs the data processed by the data processing unit 130. The output unit 140 can include a display unit (not shown) and a speaker (not speaker). The data processing unit 130 generates a screen by rendering the video data and the text of the assembled data, and then displays the generated screen using the display unit. The audio data processed by the data processing unit 130 is output using the speaker. Thus, even when the video data, the audio data, the normal data, and the other data are received through separate routes, they are combined to provide one multimedia service.

The aggregation information can be recorded to the stream in various manners. Hereafter, various embodiments of the aggregation information transmission are described.

In the first embodiment, the aggregation information can be recorded to an elementary stream loop in the program map table of the stream and provided to the receiver 100.

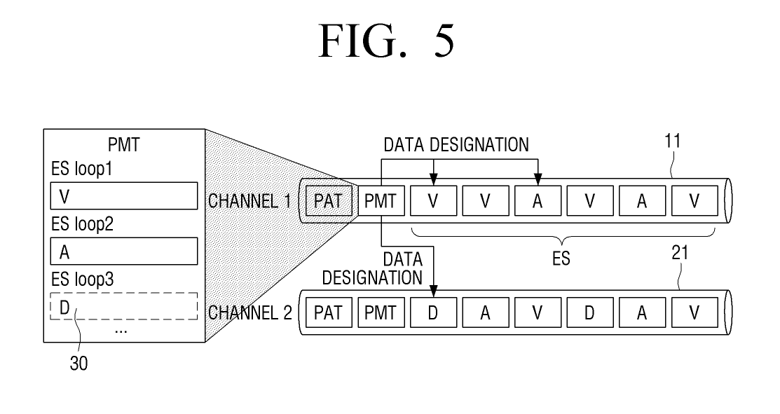

FIG. 5 depicts a method for providing the aggregation information using the elementary stream loop. Referring to FIG. 5, the first stream 11 transmitted through channel 1 includes a Program Association Table (PAT), a Program Map Table (PMT), video data V, and audio data A.

The PAT lists program numbers and PMT Packet IDentifiers (PIDs) of one or more programs provided in one TS. The PMT provides PID and information of media components in one program. When one TS contains a plurality of programs, a plurality of PMTs can be included. The information of each PMT is stored to the PAT.

In FIG. 5, the PMT in the first stream 11 includes the elementary stream loop recording elementary stream information. In this embodiment, the elementary stream loop is additionally defined to provide the aggregation information. Unlike the existing elementary stream loop, the aggregation information can designate the media data not provided in the TS. That is, the PMT includes an elementary stream loop 1 including information of the video data V on the first stream, an elementary stream loop 2 including information of the audio data A of the second stream, and an elementary stream loop 3 including the aggregation information 30 of the data D of the second stream as shown in FIG. 5.

The elementary stream loop 1 can contain video stream type (VIDEO stream_type) information, PID information (VIDEO PID), and VIDEO DESCRIPTOR information. The elementary stream loop 2 can contain audio stream type information (AUDIO stream_type) of the audio elementary stream A, PID information (AUDIO PID), and AUDIO DESCRIPTOR information. The aggregation information 30 in the elementary stream loop 3 can include at least one of data type provided in the other stream, data transport type, data separator, PID, URL, and manifest information.

The data type indicates the type of the data to aggregate in the other stream, and can include video, image vector graphic, text, timed text, audio, speech, scene descriptor, web contents, application, and metadata. The data transport type indicates transmission format of the data in the other stream and can include TS, TS over IP, and IP. The data separator, which separates the data, includes channel frequency, original network ID, network ID, and TSID. The PID can be elementary PID designating the data in the stream transmitted in the other route, and the URL information or the manifest information can be information for designating the source of the corresponding data.

Meanwhile, the information of the source for providing the second stream can vary based on the type of the protocol of the second stream transmission. For example, the second stream can be a real-time stream transmitted using the protocol such as RTP or HTTP. When the HTTP is used, metadata should be provided. Hence, the aggregation information can include address information of the source for obtaining the metadata.

The metadata provides information regarding where multimedia contents are received. A metadata file can be distinguished variously according to the type of the HTTP-based streaming. That is, in the smooth streaming, Internet Information Service (IIS) Smooth streamlining Media (ism) file is used as the metadata file. In Internet Engineering Task Force (IETF) HTTP live streaming, m3v8 file is used as the metadata file. In adaptive HTTP streaming Rel. 9 adopted by 3GPP, adaptive HTTP streaming Rel. 2 adopted by OIPF, and dynamic adaptive streaming over HTTP adopted by MPEG, Media Presentation Description (MPD) can be used as the metadata file. The metadata file can contain information the client should know in advance, such as content time locations corresponding to a plurality of separate files, URL of the source for providing the corresponding file, and size.

In FIG. 5, the data D in the second stream 21 is designated using the Elementary Stream (ES) loop 3 in the PMT of the first stream 11. The receiver receiving the stream of FIG. 5 assembles and processes the video data V, the audio data A, and the data D according to the aggregation information of the PMT.

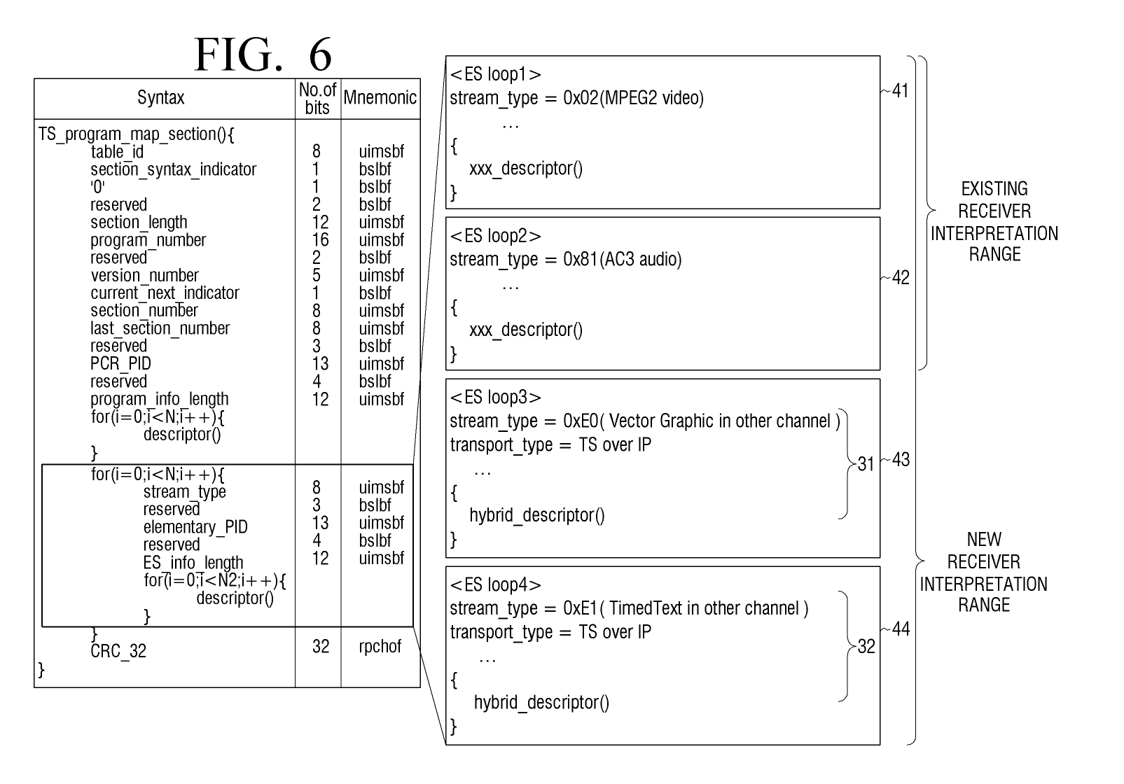

FIG. 6 depicts the PMT and the ES loop. Referring to FIG. 6, the program map table lists program number, version number, section number, indicators and reserved areas, and ES loops 41 through 44.

The first and second ES loops 41 and 42 are information interpretable by the existing receiver, and the third and fourth ES loops 43 and 44 are information interpretable by a new receiver. The number of the ES loops is determined by the number of the media. Attributes of the media can be provided through the stream type and the descriptor of the ES loop.

Since the stream transmitted in the other route is defined as the new stream type in the third and fourth ES loops, the existing receiver which cannot recognize the new stream type ignores the corresponding ES loop. Thus, backward compatibility with the existing receiver can be maintained.

The third ES loop 43 contains aggregation information 31 including data indicating that the stream of the vector graphic type is transmitted using TS over IP and its data ID. The fourth ES loop 44 contains aggregation information 32 including data indicating that the stream of the timed text type is transmitted using TS over IP and its data descriptor.

To construct the program unit provided by the program map table, the new receiver capable of recognizing the new stream type can play the data transmitted in the other route by fetching or associating the data using the information of the third and fourth elementary stream loops.

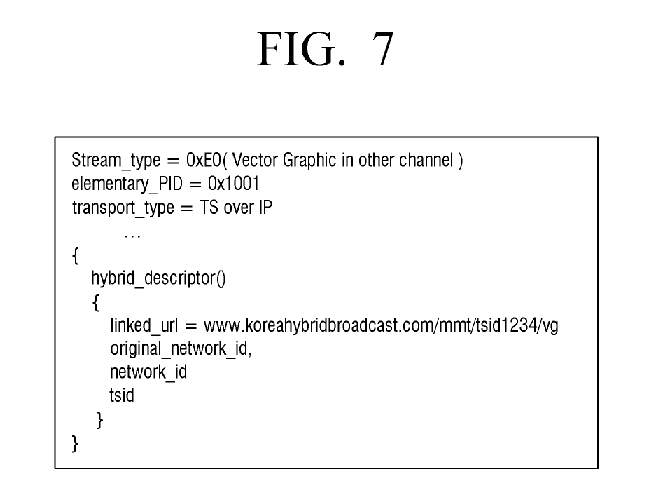

FIG. 7 is a detailed diagram of the ES loop including the aggregation information for designating the media of the other route. Referring to FIG. 7, various aggregation information such as stream type, elementary PID, transport type, hybrid descriptor, linked URL, original network ID, network ID, and TSID are described in the ES loop.

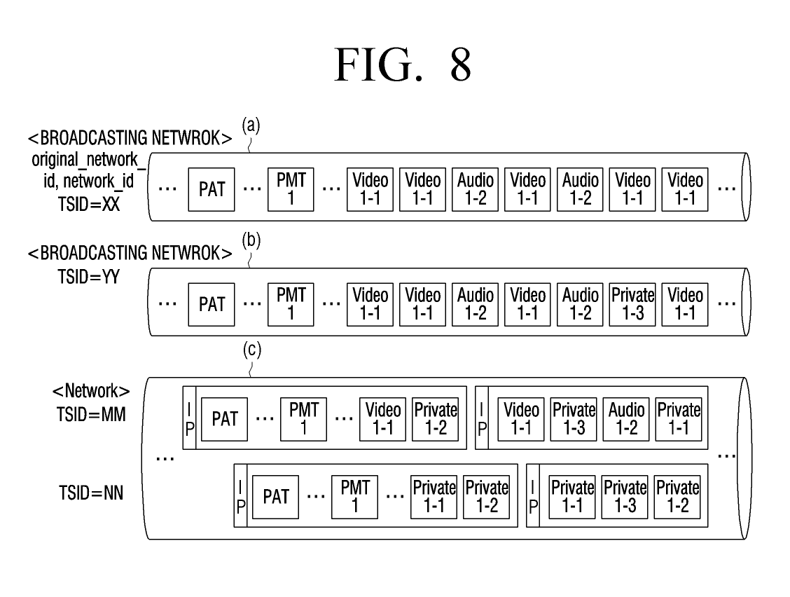

FIG. 8 depicts the stream transmitted via the communication network using TS over IP. Referring to FIG. 8, the streams a and b transmitted over the broadcasting network include the PAT, the PMT, and various elementary streams. The PMT can contain the aggregation information as stated earlier. By contrast, the stream c transmitted over the communication network IP-packetizes and transmits the TS with an IP header attached. When the PMT of the stream a with TSID=XX designates Private 1-3 of the stream c together with Video 1-1 and Audio 1-2 in FIG. 8, Video 1-1 and Audio 1-2 of the stream a and Private 1-3 of the stream c are assembled and processed together. Such data need to be played in association. For example, video data, audio data, and subtitle data which create the left-eye image and the right-eye image or the single scene should be played in association.

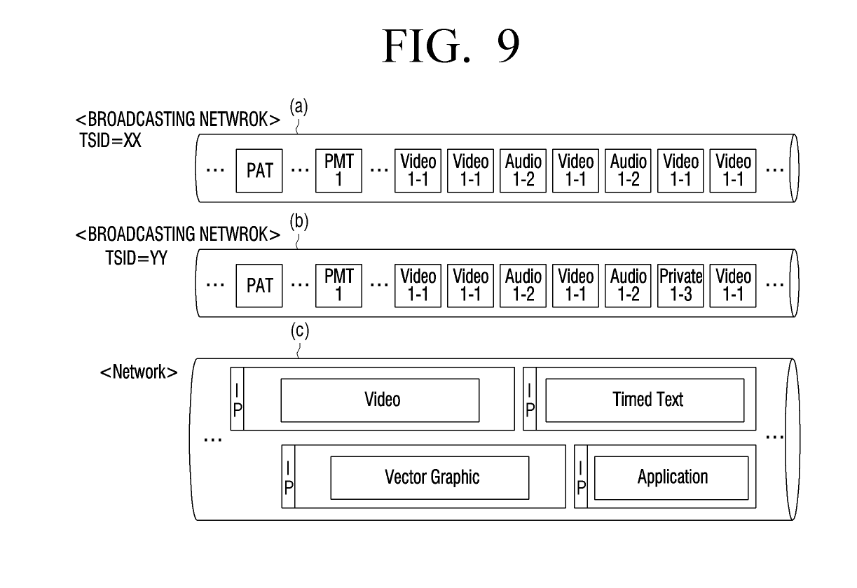

FIG. 9 depicts the stream transmitted over the communication network using IP. Referring to FIG. 9, streams a and b transmitted over the broadcasting network include the PAT, the PMT, and various elementary streams. By contrast, a stream c transmitted over the communication network contains various data IP-packetized, such as video data, vector graphic, timed text, and application. The IP header is attached to each packet, and data is recorded in IP payload. According to the aggregation information recorded in the PMT of the streams a and b, the data of the IP packets and the elementary stream data of the streams and b can be assembled and processed as well in FIG. 9.

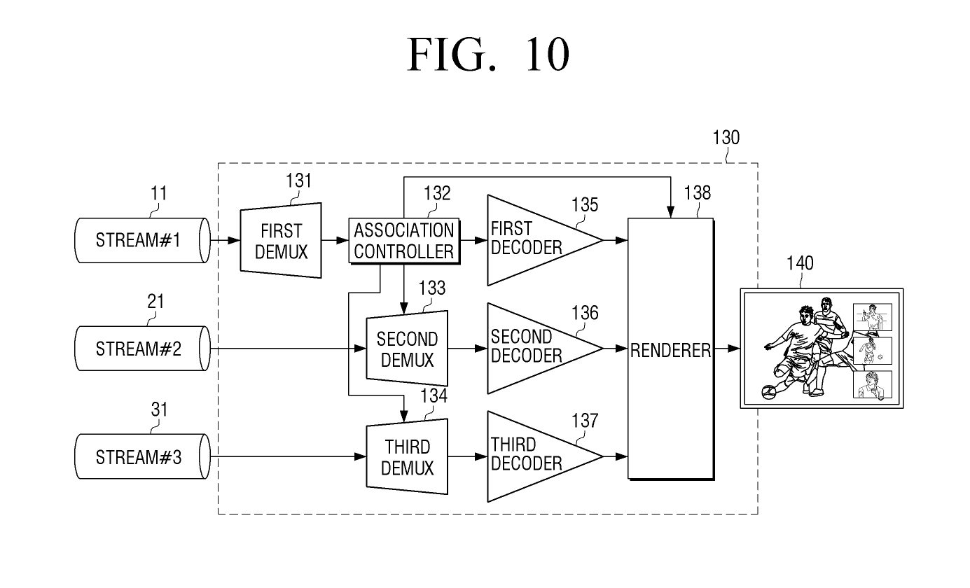

FIG. 10 is a block diagram showing the data processing unit when the aggregation information is carried by the PMT. Referring to FIG. 10, the data processing unit 130 includes a first DEMUX 131, an association controller 132, second and third DEMUXes 133 and 134, first, second and third decoders 135, 136 and 137, and a renderer 138.

In FIG. 10, the transport streams transmitted over the communication network are subordinate to the transport stream received over the broadcasting network. For example, when one multimedia data size is too big and it is hard to receive all of the data over the broadcasting network, the data can be divided and some data can be transmitted over the communication network. In this case, the information of the source for providing the data transmitted over the communication network can be carried by the aggregation information in advance over the broadcasting network. Hence, the stream received over the broadcasting network is first demultiplexed using the first DEMUX 131, and the other streams are received using the detected aggregation information in FIG. 10.

In FIG. 10, the stream #1 11 is the stream received over the broadcasting network, and the streams #2 21 and #3 31 are the streams received over the communication network. That is, the second receiving unit 120 of FIG. 4 can receive two or more streams over the communication network. Herein, the stream received over the broadcasting network is referred to as a first stream and the stream received over the communication network is referred to as a second stream to ease the understanding. In FIG. 10, the streams #2 and #3 correspond to the second stream.

The first DEMUX 131 detects the data and the aggregation information by demultiplexing the first stream 11. The data can be realized variously using video, audio, normal data, additional data, and subtitle data, and is demultiplexed by the first DEMUX 131 according to the PID.

The first DEMUX 131 detects the aggregation information from the PMT of the first stream 11 and provides the detected aggregation information to the association controller 132.

The association controller 132 controls the second receiving unit 120 to receive the second stream according to the aggregation information. That is, the association controller 132 controls the second receiving unit 120 to receive the second stream by accessing the source of the second stream using the URL information or the manifest information of the aggregation information.

The second receiving unit 120 receives the streams #2 21 and #3 31 under the control of the association controller 130. The second DEMUX 133 detects the data from the stream #2 21 received at the second receiving unit 120. The third DEMUX 134 detects the data from the stream #3 31.

The first decoder 135, the second decoder 136, and the third decoder 137 decode the data demultiplexed from the stream #1 11, the stream #2 21, and the stream #3 31. That is, the first decoder 135, the second decoder 136, and the third decoder 137 receive and decode the data detected by the first DEMUX 131, the second DEMUX 133, and the third DEMUX 134. While one decoder is matched to one stream in FIG. 10, separate decoders are equipped according to the data type such as video data, audio data, and normal data.

The renderer 138 assembles and renders the data designated by the aggregation information among the data decoded by the first, second, and third decoders 135, 136 and 137. The operations of the renderer 138 can be controlled by the association controller 132. That is, the association controller 132 can confirm the aggregation information and assemble the data by controlling the renderer 138 according to the confirmation result.

The renderer 138 provides the processed data to the output unit 140 to output the data. While the screen is output through the display unit in FIG. 10, a sound signal can be output through the speaker when the assembled data includes the audio data.

While three streams are received and the data of the transport streams are assembled according to the aggregation information in FIG. 10, the number of the transport streams is not limited three. That is, only two streams may be received and assembled. In this case, two DEMUXes and two decoders are equipped.

So far, while the aggregation information is contained only in the program map table of the first stream, the aggregation information may be contained in both of the program map tables of the first and second streams or only in the program map table of the second stream.

While the aggregation information is recorded in the elementary stream loop of the program map table of the stream, the aggregation information may be provided in other different fashions.

That is, for example, a new region recording the aggregation information can be prepared in the stream.

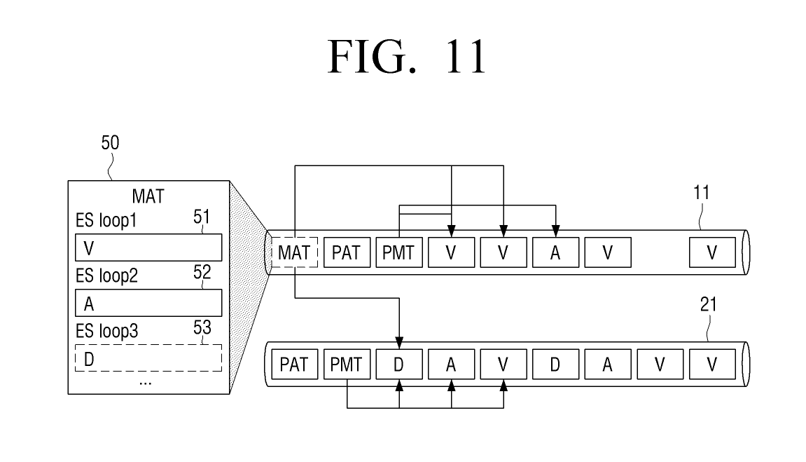

FIG. 11 depicts the aggregation information transmission using the multimedia association table. The Multimedia Association Table (MAT) is a new table defined to assemble the data transmitted in the separate routes. The MAT is at an upper level of the PAT and can include the existing PAT and PMT functions.

Referring to FIG. 11, the MAT 50 includes ES loops 51, 52 and 53 recording the information of the data to assemble. The ES loop3 53 includes the aggregation information designating the data D of the second stream 21.

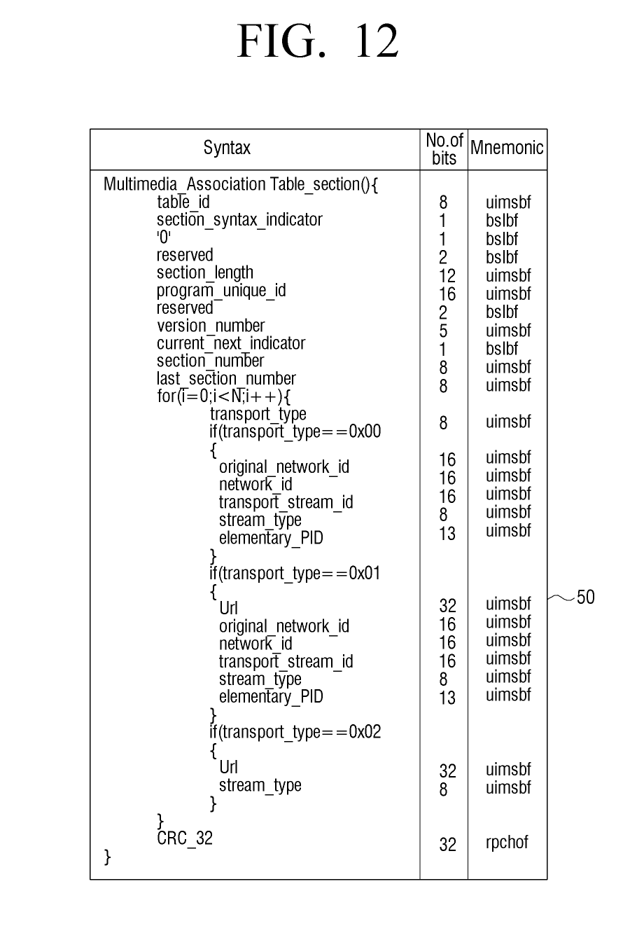

FIG. 12 depicts the MAT 50. Referring to FIG. 12, the ES loops including indicators, version numbers, and section numbers are recorded in the MAT 50. The existing receivers bypass the MAT 50, and the new receivers can recognize the MAT 50 and generate a new program unit.

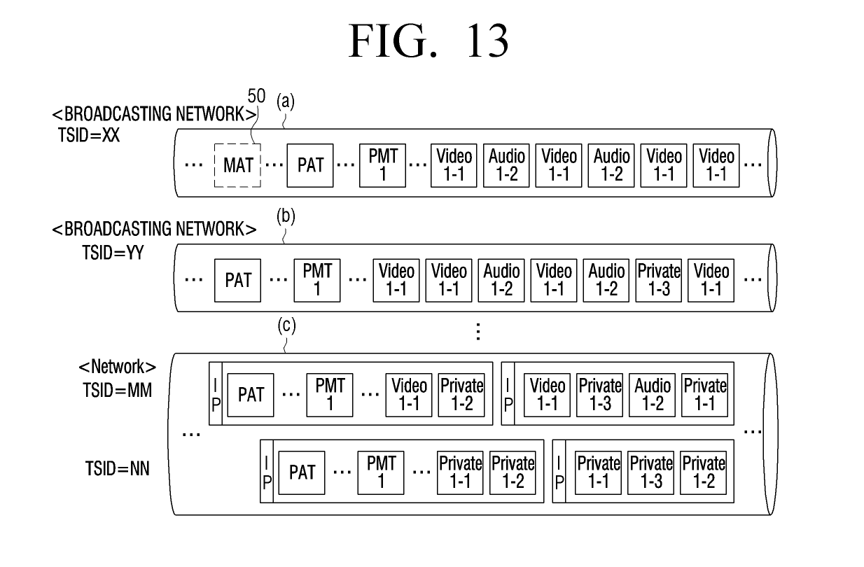

FIG. 13 depicts the stream including the MAT 50 and the other stream. Referring to FIG. 13, the MAT 50 is recorded in the first stream a of the streams a, b and c received over the broadcasting network and the communication network. The stream c received over the communication network includes packets of the TS over IP type.

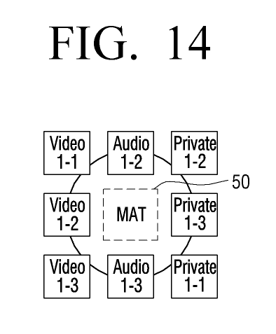

FIG. 14 depicts the assembly of video data 1-1, 1-2 and 1-3, audio data 1-2 and 1-3, and private data 1-1, 1-2 and 1-3 using the MAT 50 of the stream of FIG. 13.

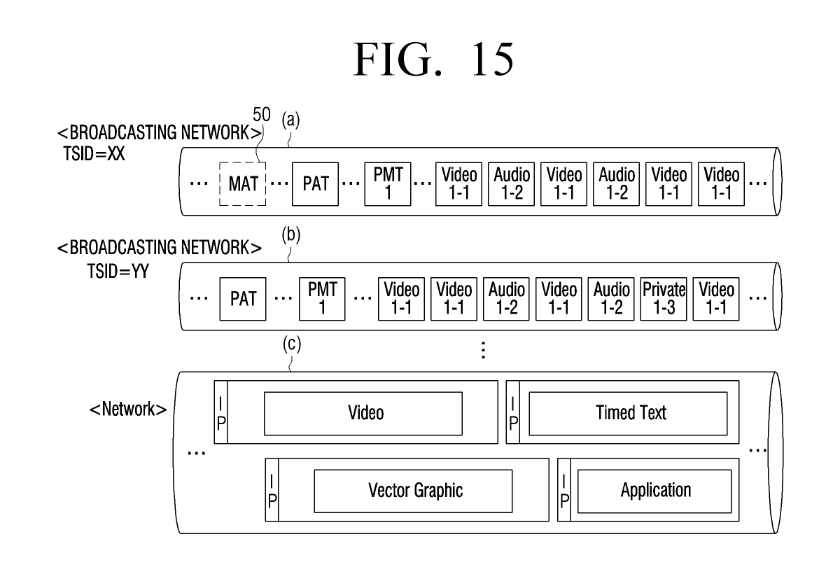

FIG. 15 depicts the stream including the MAT 50 and the other stream. The stream c received over the communication network includes packets of the IP type in FIG. 15.

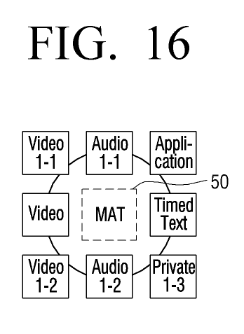

FIG. 16 depicts the assembly of video data, video data 1-1 and 1-2, audio data 1-2 and 1-3, application, timed text, and private data 1-3 using the MAT 50 of the stream of FIG. 15.

As shown in FIGS. 13 through 16, the data of the streams of the separates routes can be assembled using the MAT 50. While only one stream a includes the MAT 50 in FIGS. 13 and 15, the MAT 50 can be contained in all of the streams a, b and c or only in the other streams b and c.

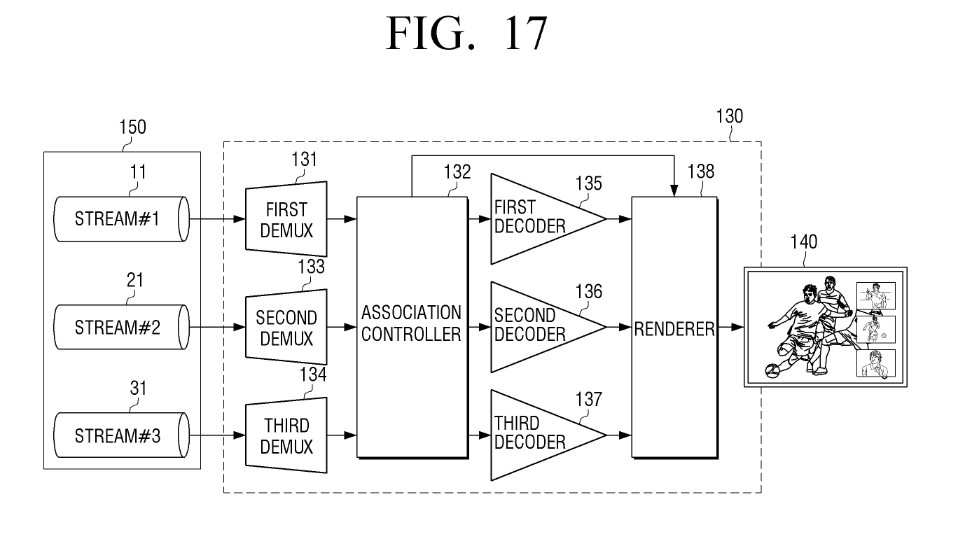

FIG. 17 is a block diagram showing the data processing unit 130 when the aggregation information is transmitted using the MAT 50.

Referring to FIG. 17, the receiver 100 can further include a storage unit 150. The storage unit 150 stores the streams #1 11, #2 21 and #3 31 received at the receiving units 110 and 120. Unlike FIG. 10, the streams can be received and stored in advance in FIG. 17. That is, the data of the streams are relevant but not subordinate in the data processing unit 130. For example, when a baseball game is broadcast, the stream #1 can transmit video data and audio data captured in view of the pitcher and the streams #2 and #3 can transmit video data and audio data captured in view of the catcher or the first baseman. In this case, the receiver 100 may assemble the data using the aggregation information and then display the assembled data in a different screen section so that the user can view the contents from various viewpoints, or play only particular data according to user's selection. As such, when the relevant but independent data are processed, the data processing unit 130 can be constructed as shown in FIG. 17.

Referring to FIG. 17, the first DEMUX 131, the second DEMUX 132, and the third DEMUX 133 receive and demultiplex the streams #1 11, #2 21 and #3 31. When each stream includes the MAT, the first, second and third DEMUXes 131, 132 and 133 detect the aggregation information of the MAT together with the data. The aggregation information detected by the first, second and third DEMUXes 131, 132 and 133 are referred to as first, second and third aggregation information to ease the understanding.

The first, second and third aggregation information detected are provided to the association controller 132. The association controller 132 determines the data to assemble within the streams #1 11, #2 21 and #3 31 using the first, second and third aggregation information, and assembles the determined data.

The association controller 132 provides the assembled data to the first, second and third decoders 135, 136 and 137 to decode the data.

The operations of the association controller 132 and the structure of the decoders can vary in the implementations.

For example, when the association controller 132 directly assembles the data, the association controller 132 can assemble the data according to the aggregation information, classify the data based on the data type, and send the data to the corresponding decoder. In this case, the first, second and third decoders 135, 136 and 137 can be equipped based on data type, such as video decoder and audio decoder. For example, when the first, second and third decoders 135, 136 and 137 are the video decoder, the audio decoder, and the data decoder, the video data of the assembled data can be fed to the first decoder 135, the audio data can be fed to the second decoder 136, and the data can be fed to the third decoder 137.

For example, when the association controller 132 assembles the data by controlling the renderer 138, the decoders 135, 136 and 137 each can include all of the video decoder, the audio decoder, and the data decoder. In this case, the association controller 132 controls to decode the data by mapping the first, second and third decoders 135, 136 and 137 to the stream #1 11, the stream #2 21, and the third stream #3 31. After the decoders decode the data, the association controller 132 can control the renderer 138 to assemble and render the data.

The data rendered by the renderer 138 are output by the output unit 140 through at least one of the display unit and the speaker.

The aggregation information in the MAT can include at least one of the data type, the data transport type, the data separator, the PID, the URL, and the manifest information as mentioned above, which has been described already and shall not be further explained.

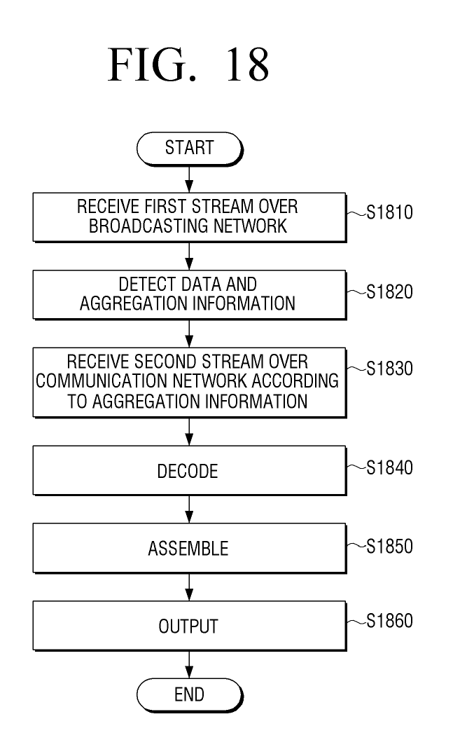

FIG. 18 is a flowchart showing a stream processing method according to an embodiment of the present general inventive concept. Referring to FIG. 18, the receiver receives the first stream over the broadcasting network (S1810). The receiver detects the data and the aggregation information from the first stream received (S1820). The aggregation information may be recorded in the ES loop of the PMT or in the MAT separately as described in relation to various embodiments described earlier. The placement, the contents, and the format of the aggregation information have been explained in detail earlier and shall not be further described.

The receiver receives the second stream over the communication network by accessing the source of the second stream according to the detected aggregation information (S1830). Next, the receiver detects the data designated by the aggregation information in the received second stream and decodes the detected data (S1840). The data designation can be checked using the PID. That is, the receiver detects and decodes the packet having the PID in the aggregation information. The other data undesignated may be discarded or stored to a separate memory.

When all of the designated data are received and decoded, the receiver assembles the decoded data (S1850) and outputs the assembled data (S1860). When only the video data are assembled, the receiver displays the video data on the screen. When only the audio data are assembled, the receiver outputs the sound signal through the speaker. When the video and audio data are assembled, the receiver can synchronize the output point of the data and output the data through the display unit and the speaker.

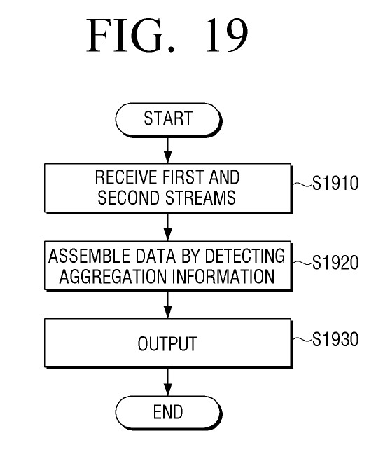

FIG. 19 is a flowchart showing a stream processing method of the receiver according to another embodiment of the present general inventive concept. Referring to FIG. 19, the receiver receives the first and second streams (S1910). When the aggregation information is detected from at least one of the first and second streams, the receiver assembles the data using the detected aggregation information (S1920). Next, the receiver outputs the assembled data (S1930). The aggregation information can be transmitted using the PMT or the MAT as described before.

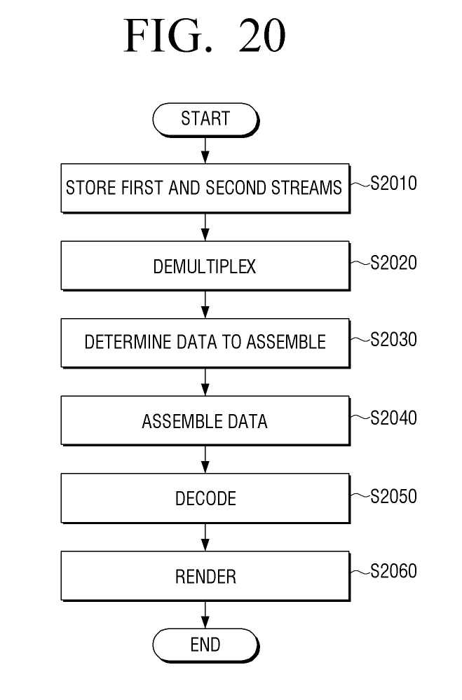

FIG. 20 is a detailed flowchart showing the data processing step in the stream processing method of FIG. 19. Referring to FIG. 20, the receiver stores the received first and second streams (S2010).

The receiver demultiplexes the stored streams (S2020), detects the aggregation information, and determines the data to assemble using the aggregation information (S2030). The receiver assembles the determined data (S2040) and decodes the data (S2050). Hence, the receiver generates the output data in the output format by applying the adequate signal processing, such as rendering (S2060), to the decoded data. Next, the receiver provides the output data to at least one of the display unit and the speaker to output the data. Since the operations of the receiver have been described in detail in FIG. 17 and the related description, their further explanations is not provided herein.

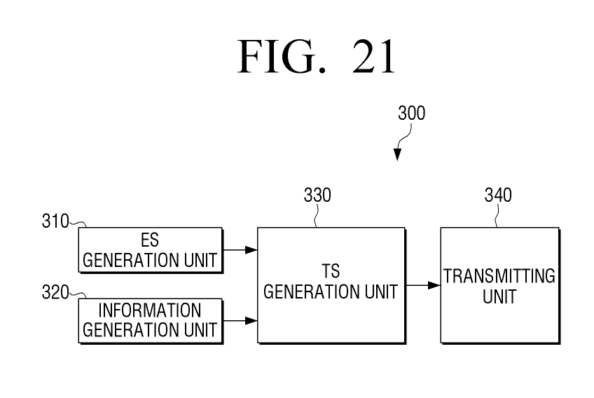

FIG. 21 is a block diagram showing a transmitter according to an embodiment of the present general inventive concept. Referring to FIG. 21, the transmitter 300 includes an ES generation unit 310, an information generation unit 320, a TS generation unit 330, and a transmitting unit 340. The transmitter 330 of FIG. 21 can be implemented using a broadcasting transmitter of a broadcasting station or a web server.

The ES generation unit 310 generates the elementary stream including the data. The data to be included to the elementary stream can include, but not limited to, video, image vector graphic, text, timed text, audio, speech, scene descriptor, web contents, application, and metadata. The ES generation unit 310 can generate the elementary stream by receiving the data from various external sources such as content providers.

The information generation unit 320 generates the information of the elementary stream.

According to one embodiment, the information generation unit 320 generates the PMT information corresponding to the elementary stream. The information generation unit 320 generates the aggregation information related to the other data to assemble with the data of the elementary stream and records the generated aggregation information in the elementary stream loop included in the PMT. The information generation unit 320 also generates the PAT including the PMT information. As mentioned earlier, the aggregation information can include at least one of the type, the transport type, the data separator, the PID, the URL, and the manifest information of the other data. The aggregation information can be provided from the corresponding program or directly from the content provider.

The TS generation unit 330 generates the transport stream including the elementary stream, the PMT information, and the PAT information.

According to another embodiment, the information generation unit 320 generates the PMT information and the PAT information of the elementary stream and then generates the MAT including the aggregation information of the other data relating to the data in the elementary stream. The construction and the placement of the MAT have been described in detail earlier and is not repeated here.

The TS generation unit 330 generates the transport stream including the elementary stream, the MAT, the PAT, and the PMT.

Meanwhile, the TS generation unit 330 includes a MUX, an RS encoder, and an interleaver for multiplexing, RS-encoding, and interleaving the generated data according to r embodiments described earlier.

The transmitting unit 340 processes and transmits the transport stream generated by the TS generation unit 330 according to a preset communication standard. For example, according to ATSC standard, the transmitting unit 340 can transmit the transport stream by applying randomization, RS encoding, interleaving, trellis encoding, field sync and segment sync multiplexing, pilot insertion, 8 VSB modulation, and RF up-converting to the transport stream. These processes have been described in detail in standard documents and related art documents and thus shall be omitted. By contrast, when the transmitter transmits the transport stream over the communication network, the transmitting unit 340 may IP-packetize and transmit the transport stream generated by the TS generation unit 330.

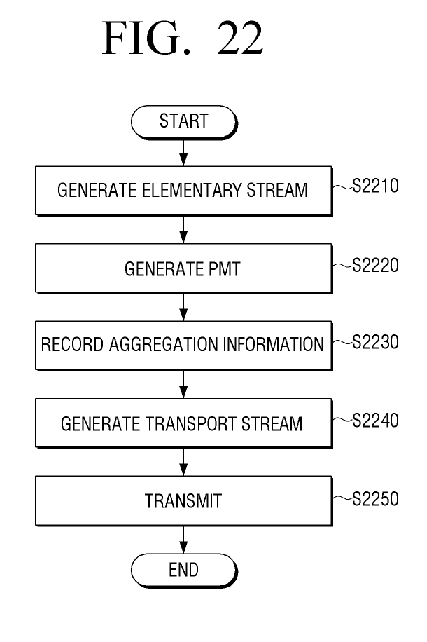

FIG. 22 is a flowchart showing a stream transmitting method of the transmitter according to an embodiment of the present general inventive concept. Referring to FIG. 22, the transmitter generates the elementary stream (S2210) and generates the PMT including the information related to the data in the elementary stream (S2220). The aggregation information is recorded in the PMT (S2230). For an easier understanding, While the aggregation information is recorded after the PMT is generated in the flowchart shown in FIG. 22, the aggregation information can be recorded when the PMT is generated. When the PMT is generated, the transmitter generates the PAT including this information, generates the transport stream including the elementary stream, the PMT, and the PAT (S2240) and then transmits the transport stream (S2250).

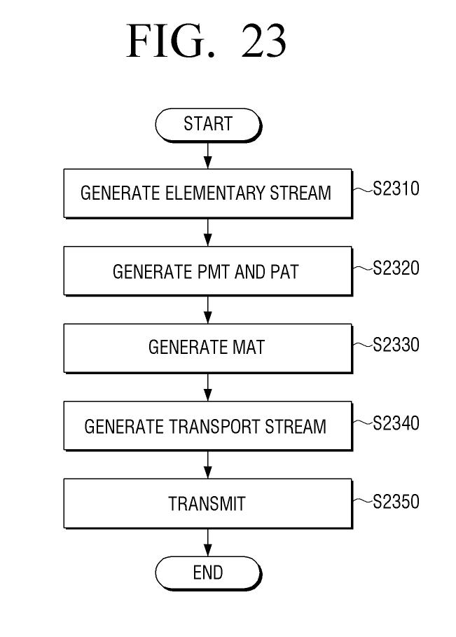

FIG. 23 is a flowchart showing a stream transmitting method of the transmitter according to another embodiment of the present general inventive concept.

Referring to FIG. 23, the transmitter generates the elementary stream (S2310) and generates the PMT and the PAT (S2320). Next, the transmitter generates the MAT including the aggregation information (S2330). The transmitter generates the transport stream including all of the information and the elementary stream (S2340). The generated transport stream is processed and transmitted according to a communication standard (S2350).

As set forth above, the multiple media data for constituting one program unit are transmitted in the separate routes and the aggregation information is provided together so that the receiver can properly assemble and process the data.

Thus, not only the data, such as left-eye image and right-eye image, video data, and audio data, which needs to be played in association with each other, but also the data which are relevant and playable independently can be assembled and processed as stated above using the general inventive.

A program for executing the method according to various embodiments of the present general inventive concept can be stored in various recording media, and used in appropriated devices.

Specifically, a code for executing the methods can be stored to various computer-readable recording media such as Random Access Memory (RAM), flash memory, Read Only Memory, (ROM), Erasable Programmable ROM (EPROM), Electronically Erasable and Programmable ROM (EEPROM), register, hard disc, removable disc, memory card, USB memory, and CD-ROM.

Although a few embodiments of the present general inventive concept have been shown and described, it would be appreciated by those skilled in the art that changes may be made in these embodiments without departing from the principles and spirit of the invention, the scope of which is defined in the claims and their equivalents.

What is claimed is:

1. A receiver comprising:
a first receiving unit which receives a first stream over a broadcasting network;
a second receiving unit which receives a second stream over a communication network;
a data processing unit which detects aggregation information from at least one of the first and second streams, and which assembles and processes data from the first stream and data from the second stream according to the aggregation information; and
an output unit which outputs the data processed by the data processing unit.

2. The receiver of claim 1, wherein the aggregation information is included in an elementary stream loop, the elementary stream loop being included in a program map table, the program map table being included in at least one of the first stream and the second stream.

3. The receiver of claim 1, wherein the aggregation information is included in a multimedia association table disposed above a Program Association Table (PAT) of at least one of the first stream and the second stream.

4. The receiver of claim 1, wherein the data processing unit comprises:
a first demultiplexer which detects data and the aggregation information by demultiplexing the first stream;
an association controller which controls the second receiving unit to receive the second stream according to the aggregation information;
a second demultiplexer which detects data from the second stream received by the second receiving unit;
a first decoder which decodes the data detected by the first demultiplexer;
a second decoder which decodes the data detected by the second demultiplexer; and
a renderer which assembles and renders data designated by the aggregation information.

5. The receiver of claim 1, wherein the data processing unit comprises:
a storage unit which stores the first stream and the second stream;
a first demultiplexer which detects data and first aggregation information by demultiplexing the first stream;
a second demultiplexer which detects data and second aggregation information by demultiplexing the second stream;
an association controller which determines data to assemble in the first stream and the second stream using the first aggregation information and the second aggregation information, and which assembles the determined data;
a decoder which decodes the data assembled by the association controller; and
a renderer which renders the decoded data.

6. The receiver of claim 1, wherein the aggregation information comprises at least one of a data type provided in other stream, a data transport type, a data separator, a PID, a URL, and manifest information.

7. A stream processing method comprising:
receiving a first stream over a broadcasting network;
detecting data and aggregation information in the first stream;
receiving a second stream over a communication network according to the aggregation information;
decoding the data from the first stream and the second stream;
assembling the decoded data according to the aggregation information; and
processing and outputting the assemble data.

8. The stream processing method of claim 7, wherein the aggregation information is included in an elementary stream loop of a program map table included in the first stream.

9. A stream processing method comprising:
receiving a first stream over a broadcasting network;
receiving a second stream over a communication network;
detecting aggregation information from at least one of the first and second streams, and assembling and processing data from the first stream and data from the second stream according to the detected aggregation information; and
outputting the processed data.

10. The stream processing method of claim 9, wherein the aggregation information is recorded in an elementary stream loop included in a program map table, the program map table being included in at least one of the first stream and the second stream.

11. The stream processing method of claim 9, wherein the aggregation information is recorded in a multimedia association table disposed above a program association table, the program association table being included in at least one of the first stream and the second stream.

12. The stream processing method of claim 9, wherein the processing operation comprises:
storing the first stream and the second stream;
detecting data and first aggregation information by demultiplexing the first stream;
detecting data and second aggregation information by demultiplexing the second stream;
determining data to assemble in the first stream and the second stream using the first aggregation information and the second aggregation information, and assembling the determined data;
decoding the assembled data;
rendering the decoded data and
outputting the rendered data.

13. The stream processing method of claim 9, wherein the aggregation information comprises at least one of a data type provided in other stream, a data transport type, a data separator, a PID, a URL, and manifest information.

14. A stream transmitting method comprising:
generating an elementary stream comprising data;
generating a program map table for the elementary stream;
generating aggregation information relating to other data to be assembled with the data and recording the generated aggregation information in an elementary stream loop included in the program map table; and
generating and transmitting a transport stream comprising the elementary stream and the program map table,
wherein the aggregation information comprises at least one of a type, a transport type, a data separator, a PID, a URL, and manifest information of the other data.

15. A stream transmitting method comprising:
generating an elementary stream comprising data;
generating program map table information and program association table information to be included in the elementary stream;
generating a multimedia association table comprising aggregation information relative to other data relating to the data; and
generating and transmitting a transport stream comprising the elementary stream, the multimedia association table, the program association table, and the program map table,
wherein the aggregation information comprises at least one of a type, a transport type, a data separator, a PID, a URL, and manifest information of the other data.

16. A receiver comprising:
a data processing unit that assembles and processes data received from a first stream over a first transmission environment and a second stream over a second transmission environment different from said first transmission environment, the assembling being based on aggregation information received from the first or second transmission environment;
and
an output unit that outputs the data processed by the data processing unit.

17. The receiver of claim 16, wherein the first transmission environment is a broadcasting network and the second transmission environment is a communication network.

18. A stream processing method comprising:
receiving a first stream over a first transmission environment;
receiving a second stream over a second transmission environment different from the first transmission environment;
processing data from the first stream and the second stream based on aggregation information received from the first stream or the second stream; and
outputting the processed data.

19. The stream processing method of claim 18, wherein the first transmission environment is a broadcasting network and the second transmission environment is a communication network.
